(19) United States
(12) Patent Application Publication
(10) Pub. No.: US 2013/0040481 A1
(43) Pub. Date: Feb. 14, 2013

(54) U-Channel Coaxial F-Connector

(71) Applicants: William Gray Vallely, Johns Creek, GA (US); Earl Anthony Daughtry, JR., Lawrenceville, GA (US); Ronald Hodge, Flowery Branch, GA (US)

(72) Inventors: William Gray Vallely, Johns Creek, GA (US); Earl Anthony Daughtry, JR., Lawrenceville, GA (US); Ronald Hodge, Flowery Branch, GA (US)

(73) Assignee: Genesis Technology USA, Inc., Atlanta, GA (US)

(21) Appl. No.: 13/208,786

(22) Filed: Aug. 12, 2011

(51) Int. Cl. H01R 13/622; H01R 43/16; H01R 9/05

(52) U.S. Cl. 439/312; 439/581; 29/876

(57) ABSTRACT

An F-connector for a coaxial cable comprises a front insulator, a back insulator, a connecting lead, and a locking ring. The connecting lead has an interior portion and an exterior portion. The interior portion is configured with a pair of side wall portions which are parallel to each other, and which together with a bottom portion form a U-shaped channel. The side wall portions each comprise a curved portion that are configured to grip the center conductor of the coaxial cable so as to withstand a certain level of withdrawal force, and such that the F-connector exhibits a desired impedance of 75 Ohms. The connecting lead engages with the front insulator and the back insulator such that the components are held in position within a connector body.

### BACKGROUND

Coaxial cable is frequently encountered by consumers as the cable used for radio frequency (“RF”) transmissions, particularly for conventional analog and digital video signals. More specifically, coaxial cable is typically used by cable television service providers to provide video signals to residential service locations. It can be used for other applications, including data communications involving local area networks. The structure of coaxial cable provides protection of the signal from external electromagnetic interference and largely contains the signal within the cable itself.

A common embodiment of coaxial cable comprises a center conductor (usually a solid copper wire) surrounded by an insulating layer that is enclosed by a shield layer, typically a woven metallic braid. Finally, an outer insulating jacket provides protection. Normally, the shield is kept at ground potential and a voltage is applied to the center conductor (with respect to ground) to carry the electrical signals. This property makes coaxial cable a good choice for carrying weak signals that cannot tolerate interference from the environment or for higher power signals that must not be allowed to radiate or couple into adjacent structures or circuits.

It is important that coaxial cable be terminated properly, i.e., that the connectors at the end of the coaxial cable connecting the cable to equipment does not radiate energy, and thus adversely impact the signal. The coaxial cable has a specific characteristic impedance for the frequency of the signals conveyed, and it is important that connectors used to terminate the coaxial cable are properly matched to the impedance of the cable. For a conventional coaxial cable, the impedance is provided by the mathematical expression shown in equation (1) below:

$${Z}_{o} ≡ \frac{1}{2 π} \times \sqrt{\frac{μ}{ɛ}} \times ln \frac{D}{d} \qquad eq . ( 1 )$$

where D is the shield diameter and the d is the center conductor diameter and μ and ∈ are the effective permeability and permittivity of the insulating layer (respectively).

Over the lifetime of the coaxial cable connector, it is expected that the coaxial cable will be connected/disconnected as the equipment it is connected to is installed, moved, replaced, etc. Thus, it is also important that the coaxial cable connector provide a reliable electrical connection. Further, it is important that the coaxial cable connector be easy and cost effective to manufacture.

It is with respect to these and other considerations that the disclosure made herein is presented.

### SUMMARY

Concepts and technologies are described herein for a coaxial cable F-connector which incorporates a connecting lead having a U-shaped channel that provides increased gripping force on the center conductor of the coaxial cable and that provides the desired impedance.

In one embodiment, the coaxial F-connector includes a front insulator part having a front side and a back side, said front insulator having a circular profile viewed from the front side, the front insulator part comprising a hole configured to receive a center conductor of a coaxial cable in the front side. The coaxial F-connector also includes a connecting lead that is a single piece of metal comprising an external portion and an internal portion, wherein the internal portion has three sides forming a U-shaped channel formed by a first side wall portion, a second side wall portion, and a center portion, wherein the first side wall portion is parallel to the second side wall portion, and the first side wall portion and the second side wall portion are perpendicular to the center portion. The F-connector also includes a back insulator part having an opening configured to receive the center conductor part, the back insulator affixed to the connecting lead by engaging with the first side wall portion and the second side wall portion.

In another embodiment, an apparatus includes a connecting lead having an interior portion configured to be within a coaxial connector body, and an exterior portion configured to be outside the connector body, wherein the interior portion of the connecting lead comprises a U-shaped channel shaped by a first side wall, a second side wall parallel to the first side wall, and a bottom portion, wherein the first side wall, second side wall and the bottom portion are portions of the connecting lead, wherein the first side wall and the second side wall are perpendicular to the bottom portion, and wherein the first side wall and second side wall are configured to grip a center conductor of a coaxial cable.

In another embodiment a method of assembling an F-connector includes affixing a front insulator to a connector lead, affixing a back insulator to the connector lead, inserting the front insulator, back insulator, and a portion of the connector lead inside a connector body, wherein the connector lead comprises a U-shaped channel comprising a first side wall portion and a second side wall portion, wherein the first side wall portion is parallel to the second side wall portion, and each side wall portion is perpendicular to a bottom portion, wherein the first side wall portion and the second side wall portion are configured to grip the center conductor of a coaxial cable.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a prior art schematic diagram showing a conventional co-axial cable for use with F-type coaxial connectors disclosed herein;

FIG. 2 is a perspective diagram showing one embodiment of an F-type coaxial connector as disclosed herein;

FIGS. 3A and 3B are a side view diagram and a cross-sectional view diagram respectively of one embodiment of the F-type coaxial connector as disclosed herein;

FIG. 4 is a perspective diagram showing one embodiment of components of the F-type coaxial connector as disclosed herein;

FIGS. 5A and 5B are a side view diagram and a plan view diagram of one embodiment of components of the F-type coaxial connector as disclosed herein;

FIG. 5C is a more detailed view of the plan view diagram of FIG. 5B;

FIGS. 6A-6C are three perspective view diagrams showing one embodiment of the connecting lead in the F-type coaxial connector as disclosed herein;

FIGS. 7A and 7B are top view and side view diagrams respectively illustrating one embodiment of the connecting lead in the F-type coaxial connector as disclosed herein; and

FIG. 8 illustrates a process flow for assembling the F-type coaxial connector as disclosed herein.

### DETAILED DESCRIPTION

The following detailed description is directed to a coaxial cable connector. Coaxial cable is frequently used in delivery of video signals, and consumers frequently encounter coaxial cable in conjunction with residential cable television service applications. Coaxial cable is typically used to provide video signals to a set top box or a television set by a cable service company.

In the following detailed description, references are made to the accompanying drawings that form a part hereof, and which are shown by way of illustration specific embodiments or examples. Referring now to the drawings, in which like numerals represent like elements throughout the several figures, aspects of a coaxial F-connector be presented. In general, the F-connector has several structures that are symmetrical about an axis. A particular instance of a symmetrical structure is denoted by a suffix letter (e.g., “325a” or “325b”). Reference to a symmetrical structure element without the suffix letter refers to the either instance of the structure or collectively to the symmetrical structures.

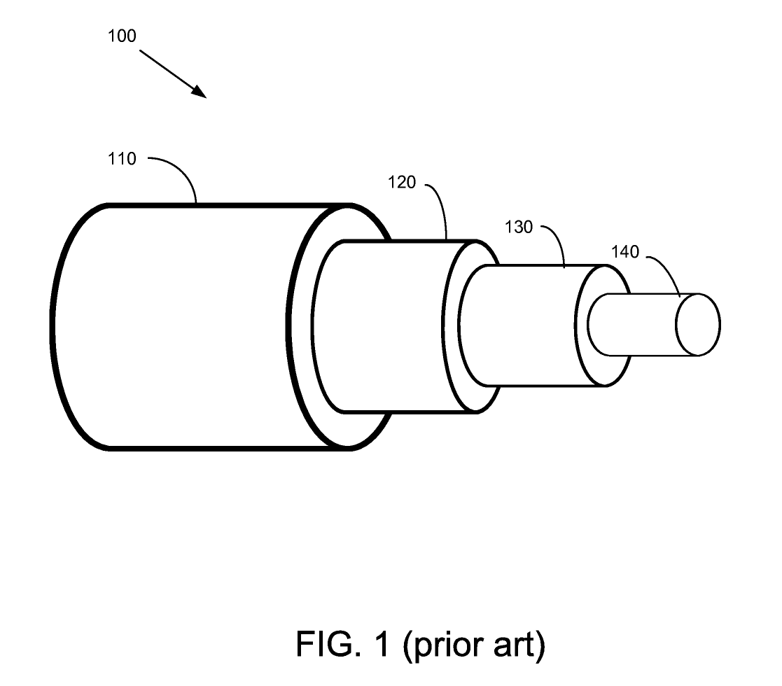

One structure for a coaxial cable is the prior art diagram shown in FIG. 1. In FIG. 1, the structure 100 comprises a center conductor center conductor 140, which is usually a copper wire. A dielectric insulator 130 surrounds the center conductor, and is typically made of foam or plastic. The insulator is surrounded by a shield 120, which prevents RF energy from radiating outside the coaxial cable. Finally, an insulating jacket 110 is used to protect the structure as the cable may be exposed to the elements. There are various types of coaxial cable known to those skilled in the art, including types referred to as “RG-6” and “RG-59” used in connecting television equipment, “RG-58” used in data communications for local area networks, and other types for other applications. For RG-6 coaxial cable, the center conductor comprises 18 AWG wire, which is about 0.0403″ or 1.024 mm in diameter.

It is necessary to terminate the coaxial cable in order to connect it to the desired device. For sake of illustration, but not for limitation, the coaxial cable is presumed to be connected to a consumer electronics (“CE”) device, such as a television set top box. In order to facilitate interconnection between the coaxial cable and CE devices, various standards have been developed defining the size and characteristics of the connector. One common connector used for coaxial cable in CE devices is known as an “F-connector.” The F-connector (also referred to as “connector” herein) typically comprises a male part and a female part. The male part typically is attached to the coaxial cable, and the female part is typically attached to the CE device. Typically, the female part is soldered to a printed circuit board or otherwise attached to the CE device. This disclosure pertains to the female part.

The coaxial cable exhibits impedance and for RG-6 and RG-59 type coaxial cable used for delivery of video signals, the impedance is nominally 75 Ohms. The design and construction of the connector impacts the impedance of the signal, and for a 75 Ohm coaxial cable, the connector should provide a corresponding nominal impedance of 75 Ohms. The determination of the impedance of a connector can be quantified, but designing a connector to achieve the target impedance can be very complicated, as a number of factors can impact the impedance of the connector, including the shape of the components used therein. Thus, relatively minor modifications to the design of the connector can adversely impact the desired impedance. Further, it can be difficult to model the impedance from a design. In many cases, the design is built and then the impedance is measured.

The shape of the interior structure of the F-connector not only impacts the impedance, but also impacts the retention force provided by the connector. The retention force pertains to the force required to pull out the center conductor from the connector when it is inserted into the F-connector. This presumes that the male connector is not present on the cable. Although the male connector is present in actual installations, and the male and female connectors have mating threads to ensure that the two connectors stay engaged, a retention force ensures that the center conductor of the coaxial cable is gripped and makes electrical contact with the F-connector. The retention force can also aid in engaging the coaxial cable with the connector if the consumer does not engage the threads of the male and female connectors. Because repeated connecting/disconnecting of a coaxial cable into an F-connector can weaken the retention force and degrade the resulting electrical connection, various tests have been defined to ensure the longevity and reliability of the F-connector.

In one testing scheme, a polished steel pin of a first diameter is repeatedly inserted into the F-connector at a certain rate. Then a polished steel pin of a second diameter is inserted into the F-connector, and this second pin should be able to withstand a certain force (the retention force) for a certain duration. Example test specifications are shown in TABLE 1.

TABLE 1

| | Number of | | | |
|---|---|---|---|---|
| First Pin | Times | Second Pin | Retention | |
| Diameter | Insertion | Diameter | Force | Duration |
| 1.05 mm | 9 | .80 mm | 200 grams | 30 sec. |
| 1.05 mm | 9 | 0.50 mm | 50 grams | 30 sec. |
| 1.194 mm | 50 | .559 mm | 25 grams | 10 sec. |

For example, in the second test shown in TABLE 1, a first pin with a diameter of 1.05 mm is inserted into the F-connector nine times, and then a second pin having a diameter of 0.50 mm is inserted into the connector. The second pin should be able to withstand a force of 50 grams for 30 seconds without being pulled out of the F-connector. As noted, this test does not involve a mating male connector, since the threads if engaged, would prevent withdrawal. Withstanding this force ensures that the center conductor is solidly engaged with the F-connector.

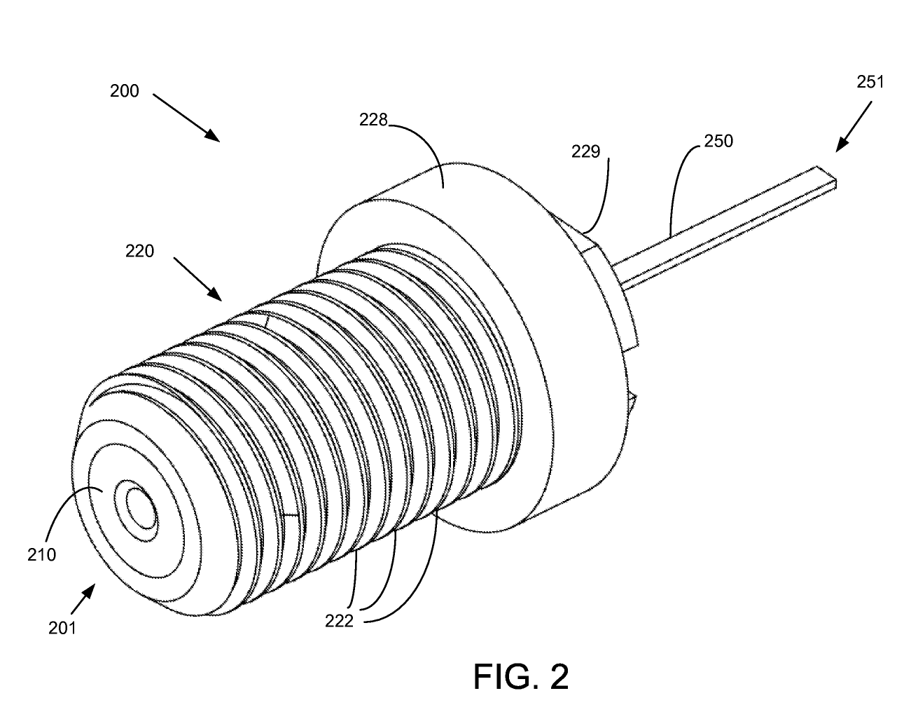

Turning now to FIG. 2, FIG. 2 is a perspective illustration of one embodiment of an F-connector 200. In this illustration, three main components are readily discernable, although other components are involved which are not readily discernable in this illustration. In other embodiments, a different number of components may be used.

For references purposes, the “front” of the connector is the end associated with front end 201 and the “back” of the connector is the back end 251. As will become evident, many of the components can be described as having a front side or back side, and this refers to the side that is facing the front end 201 or the back end 251 respectively, even though the component itself may be located towards the front portion or back portion of the connector.

Located at the front end 201 is a front insulating connector 210. This typically comprises a dielectric plastic with insulating qualities, and ensures that the center conductor 140 of the coaxial cable does not contact other portions of the connector, namely the connector body 220. In FIG. 2, only the front side of the front connector is visible.

Next, the connector body 220 typically comprises metal body, and has a series of threads 222 that mates with the male F connector. In one embodiment, the female connector includes a 3/8-32 UNEF thread, which is 9.525 mm in diameter. The reference to “threads” herein recognizes that this structure can also be described in the singular form—e.g., a single continuous “thread.”

The connector body 220 is typically connected to an electrical ground in the CE device and to the shielding of the coaxial cable. As it will be seen in the other diagrams, the connector body shape is generally of a tube-like structure. The connector body comprises a collar portion 228, and the indexing key 229 which may aid in positioning the connector 200 in a hole of the CE device or a hole in the printed circuit board. In one embodiment, the connector body is a cast and/or machines piece of metal.

Emanating from the connector body 220 is a connecting lead 250. Typically, this is soldered to a printed circuit board, and it connects to the center conductor of the coaxial cable when inserted into the connector 200. Although it is not readily discernable from this figure, the connecting lead 250 runs inside the length of the connector body 220.

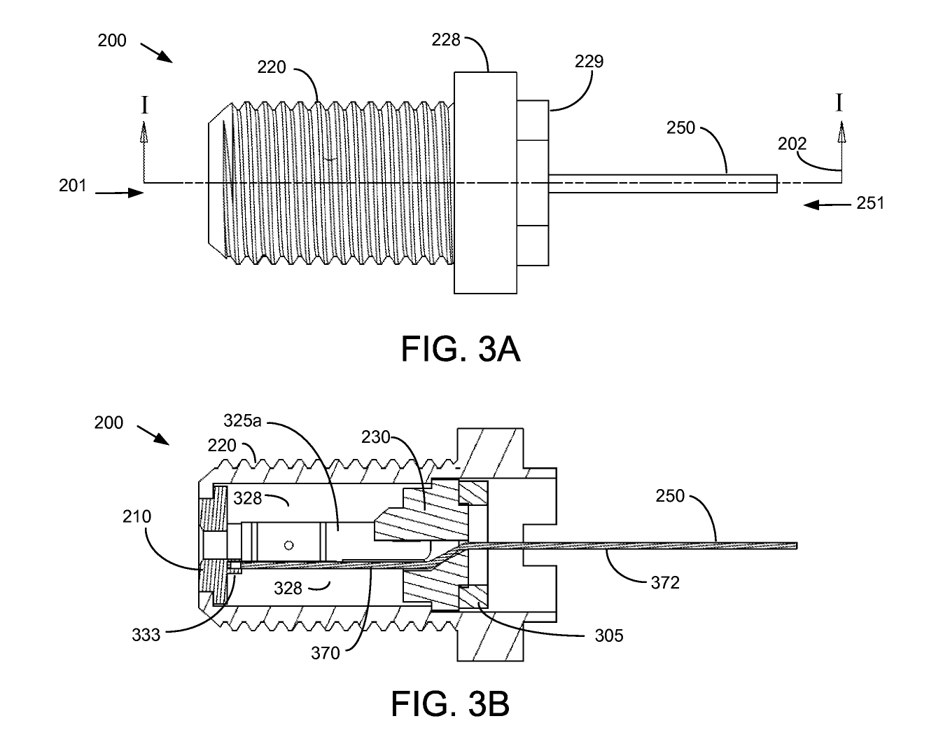

FIG. 3A shows a top view of the connector 200, again with the front end 201 to the left, and the rear end 251 to the right. The connector body 220 is shown comprising the collar 228 and indexing key 229. The connecting lead 250 is shown projecting from the connector body 220. A center axis is shown as a dotted line defining a cross section 1202, which also is the basis for a cross sectional view in FIG. 3B.

FIG. 3B shows a cross sectional side view of the connector 200 at cross section 1202. The front insulator 210 is shown as positioned inside the connector body 220. The back side of the front insulator is normally not readily visible as it is inside the assembled connector. The connector body 220 exhibits an open center portion, comprising air gaps 328.

A back insulator 230 is also positioned within the connector body 220 and holds the connecting lead 250 in position. Further, the front portion of the connecting lead engages in a receptacle 333 of the front insulator. Thus, the connecting lead 250 is held vertically (with respect to its position depicted in FIG. 3B) by the front insulator 210. In addition, because the front insulator 210 is engaged in the connector body and cannot move forward, the front insulator prevents the connecting lead 250 from moving forward.

The connecting lead is also held in position by the back insulator 230 vertically, horizontally, and laterally. A locking ring 305 is pressed into position within the barrel of the connecting body to hold the back insulator 230 in place, which in turns holds the connection lead 250, and which in turn holds the front insulator 210 in place.

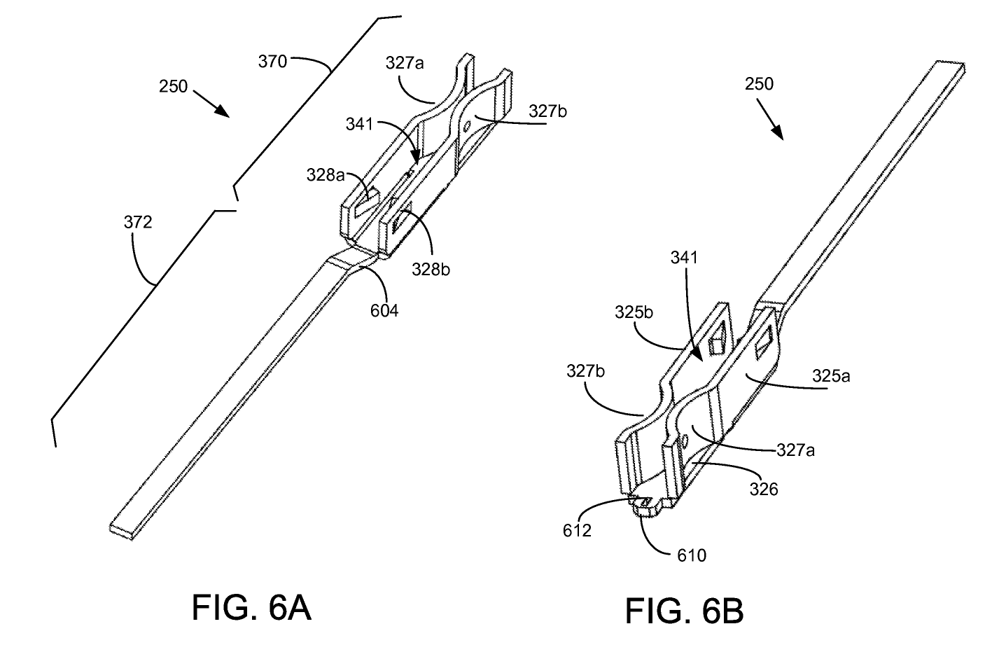

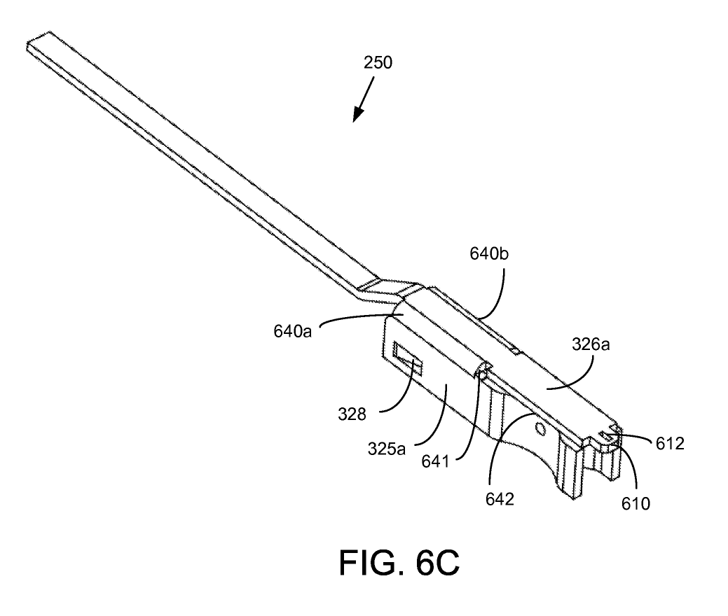

FIG. 3B also illustrates that the connecting lead 250 comprises a single piece of metal, typically sheet metal, which has a portion 370 located inside the connector body 220 and a portion 372 which is located outside the connector body 220. These are referred to for convenience as the interior portion 370 of the connecting lead and the exterior portion 372 of the connector lead. The interior portion 370 and the exterior portion can be easily appreciated when viewing FIG. 6A.

The connecting lead 250 engages the center conductor 140 of the coaxial cable. The connecting lead passes through the back insulator 230, in a U-shaped channel, as shown and is soldered to a circuit board (not shown). In this manner, the signals from the center conductor are passed to the circuit board. The back insulator 230 ensures that there is no contact between the connecting lead and the connector body. Both the back insulator 230 and the front insulator 210 are typically made of plastic with a specific dielectric constant. In one embodiment, the dielectric constant is 3.2. In this embodiment, the back insulator 230 functions in part to mate with the connecting lead 250.

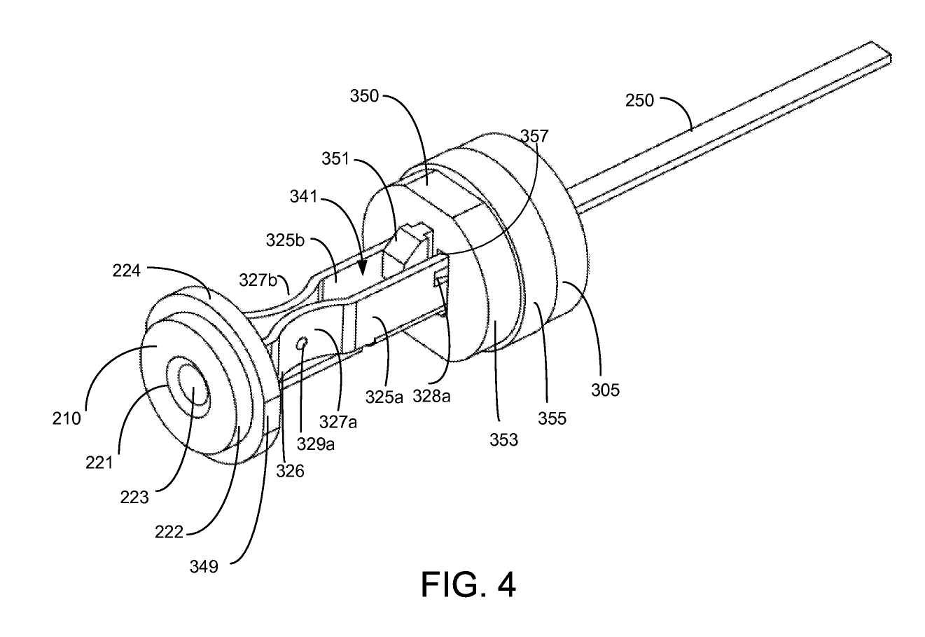

The connector lead 250 comprises two portions in the interior of the connector body that are bent, and each are referred to as a side wall. In FIG. 3B one side wall 325b is illustrated. Both side walls are readily discernable in FIG. 4, which shows the structure of the connector 200 without the connector body 220.

Turning to FIG. 4 the front insulator 210 is seen affixed to the front of connecting lead 250, and the back insulator 230 is also seen affixed to the connecting lead 250. The front insulator 210 is configured with a hole 223 to receive the center conductor 140 of the coaxial cable. The hole ensures that the center conductor does not electrically contact with the connector body part 220. Contacting the center conductor 140 with the connector body 220 would short out the signal. Thus, there should be no direct electrical contact between the connector body 220 and the connecting lead 250. The front insulator 220 also comprises a chamfer 221 or bevel around the edge to aid in guiding the core into the hole and a side shoulder 222 that fits within an opening of the connector body, to hold the front insulator in position. Behind the side shoulder 222 is a side surface 224, which is designed to contact the connector body 220. A front insulator indexing surface 349 aids in ensuring the proper rotational positioning of the front insulator within the connector body 220.

Turning to the back insulator 230, it comprises a collar portion 355 that contacts the inside of the connector body 220 and functions to center the back insulator within the body. The back insulator comprises a front shoulder portion 353 in front of the collar portion 355, and the front shoulder portion 353 is of a smaller diameter relative to the collar portion 355. The back insulator also comprises a key 351 that engages with the connecting lead 250 and an indexing surface 350 for ensuring the proper rotational positioning of the front insulator within the connector body 220. The back insulator 230 also comprises a U-shaped hole 357, into which the connecting lead 250 is inserted through.

Finally, the locking ring 305 is also shown behind the back insulator. As noted, it is a separate component from the back insulator 230, and is positioned to hold the other components within the connector body 220.

The connecting lead comprises two side wall portions 325a and 325b (collectively referred to as 325). Each side wall 325 is bent perpendicular to a center portion that is referred to as the bottom portion 326 of the connecting lead 250. Each side wall 325 has, in this embodiment, a curved contact portion 327a and 327b. The curved contact portions 327 are formed with a curvature and are configured to contact the center conductor 140 of the coaxial cable. In one embodiment, a hole 329a is formed in the side wall 325a. A corresponding hole in the other sidewall is present (not shown). In other embodiments, the hole 329 is not present in the side wall 325. In other embodiments, a bent, instead of curved contact portion, may be present.

Each side wall 325 also has a locking tab 328 formed therein. Specifically, side wall 325a has a locking tab 328a configured to protrude so as to grip on the side of key 351. When the connecting lead is inserted into the rear connector 230 during assembly, the locking tabs 328 hold key so that the two components are affixed.

The configuration of the side walls 325 and the bottom portion (not seen) form a channel 341. The channel has a “U” shape, with the sides of the channel formed by side walls 325. Each side wall 325 is of equal and constant height in this embodiment. The width of the channel at any given point, however, can vary based on shape of the sidewall 325.

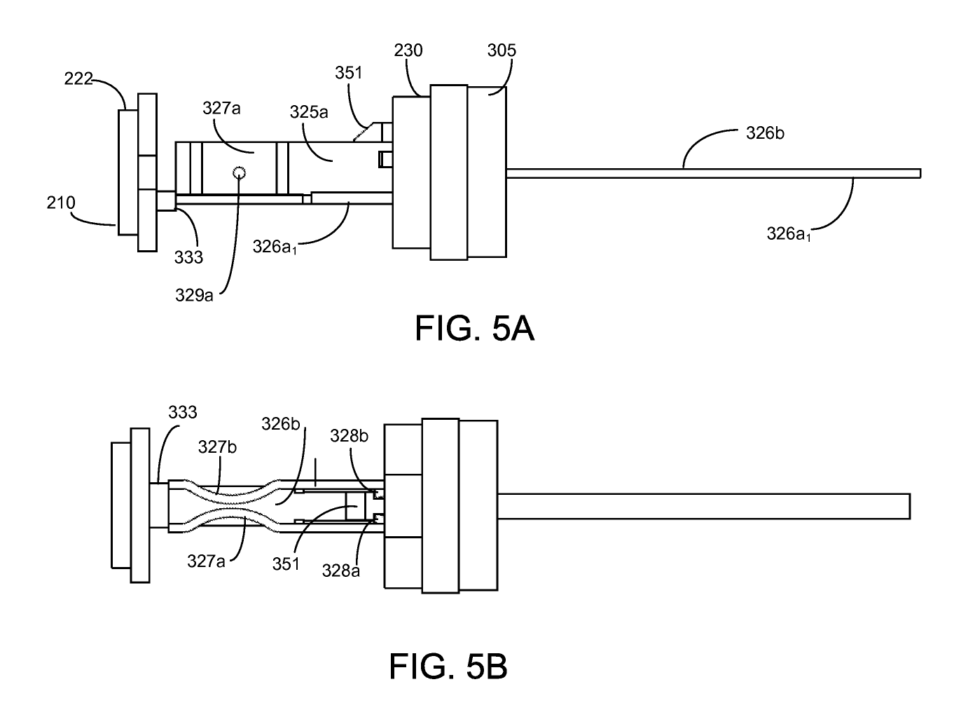

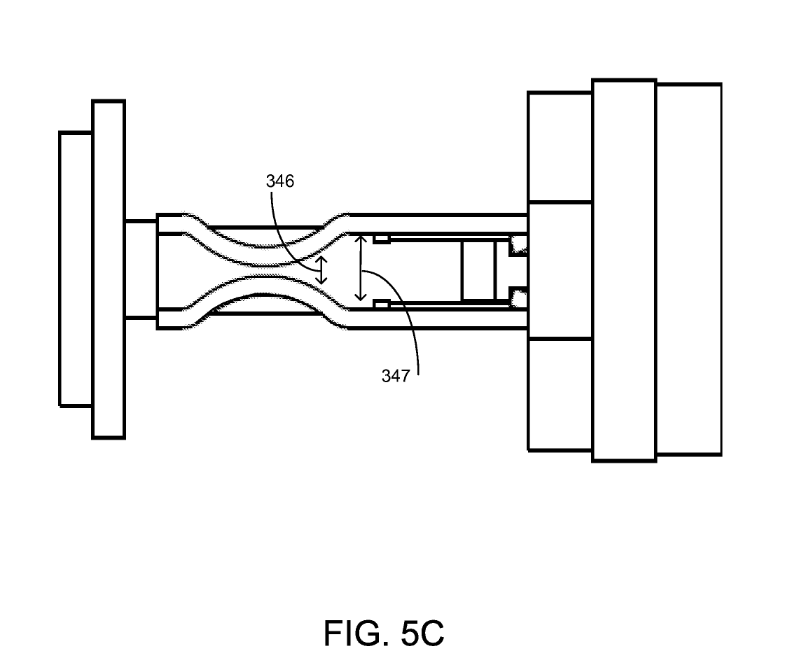

The shape of the channel and sidewalls are further illustrated in FIGS. 5A and 5B. FIG. 5A shows a side view of the front insulator 220, the back insulator 230, and the connecting lead 250. The side wall 325a is shown and forms one side of the channel, and has a constant height.

FIG. 5A also shows a bottom portion 326 of the channel which is part of the connecting lead 250. Specifically, there is a bottom surface 326a of the bottom portion. There is also a top surface (see 326b of FIG. 5B) of the bottom portion of the connecting lead 250. The bottom surface extends along the length of the connecting lead 250, as shown by numerals 326a₁ and 326a₂. The top surface 326b is seen on the exterior portion of the connecting lead 250. FIG. 5A also illustrates the receptacle 333 formed into the front insulator 220, which receives a portion of the connecting lead 250.

FIG. 5B illustrates a plan view of the connecting lead 250. FIG. 5B illustrates that curvature of the curved contact portions 327a, 327b of the respective side walls. Further, the top surface 326b of the bottom portion of the channel is seen in this view. Finally, the locking tabs 328a, 328b are seen projecting into the channel and engaging with the side of the key 351. This arrangement prevents the connecting lead 250 from sliding relative to the back insulator 230 after insertion.

FIG. 5C illustrates how the channel width varies, depending on where the width is considered along the length of the connecting lead 250. Specifically, the width of the channel 346 is less where the side walls are curved than the width of the channel 347 where the side walls are not curved.

FIGS. 6A and 6B illustrate perspective views of the connecting lead 250 only. In FIG. 6A, an interior portion 370 of the connecting lead which is inside the connector body 220 is delineated from the exterior portion 372 which is visible from outside the connector body. In various embodiments, the exact point of delineation between the interior portion 370 and the exterior portion 372 may vary, and may not be denoted by any shape change, such as the step angle 604 at the connecting lead 250. In various embodiments, the step angle 604 may not be present, or additional angles may be present.

FIGS. 6A and 6B also illustrate the channel 341 formed by the side walls 325 and the bottom surface 326. The connecting lead 250 is formed from a single piece of sheet metal where the interior portion 370 is formed by bending up the side walls 325 with the curved contact portion 327.

FIG. 6B also illustrates a nose portion 610 of the connecting lead 250 comprising a square hole 612 for engaging the receptacle 333 of front insulator 210. FIG. 6B also shows the bottom surface 326 of the channel and the curved portions 327 of the side wall 325.

FIG. 6C shows a perspective diagram of the connecting lead 250 from the bottom, which illustrates the bottom surface 326a. FIG. 6 also illustrates a bent side corner 640a and 640b of the channel where the side wall 325 meets the bottom surface 326a. The bent side corners 640a, 640b form an exterior of the channel shape, and extend along a portion of the length of the interior portion 370. Specifically, the end of the bend corner 641 ends before the curved portion 327 of the side wall 325a begins.

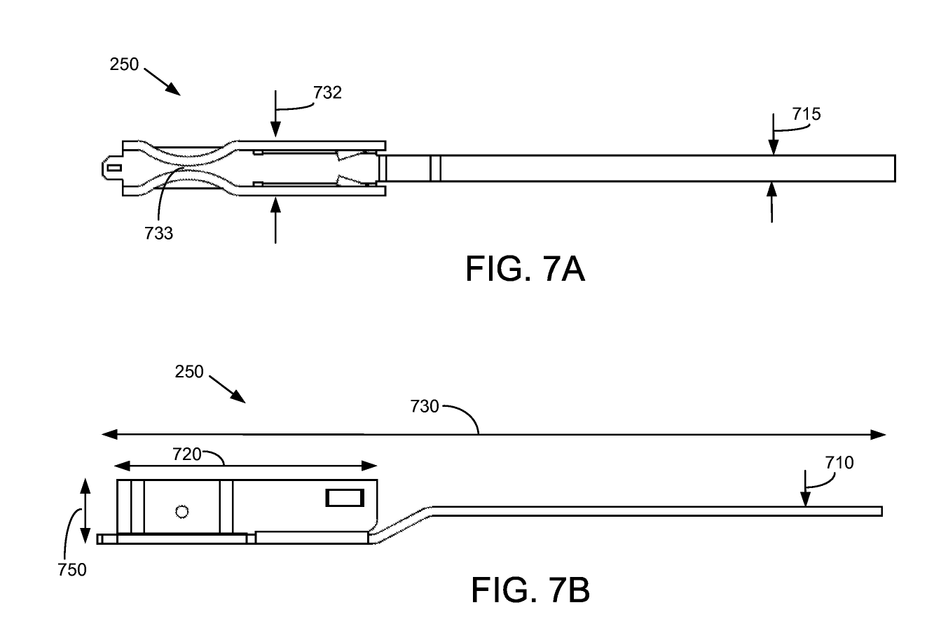

FIGS. 7A and 7B illustrate a plan view 740 and side view 750 respectively of the connecting lead 250 for purposes of illustrating the dimensions in one embodiment. In one embodiment, the thickness 710 of the connecting lead may be 0.014″. The width 715 of the connecting lead may be 0.080″. The length of the side wall 720 may be 0.450″. The gap 733 may be 0.004″. Other embodiments may use other values.

When the coaxial cable is inserted into the F-connector, the center conductor is inserted the gap 733 between the curved portions 327 of the sidewalls 325, and forces the curved portion 327 outward. This causes pressure to be exerted by the side walls 325, specifically the curved portion 327, against the respective sides of the center conductor, resulting in the curved portions holding the center conductor in place and ensuring electrical contact occurs.

The force exerted by the sidewalls is related to the thickness of the metal in the sidewalls, which is the same thickness as other portions of the connecting lead 250. By using sheet metal with a thickness of around 0.014″ (i.e., from 0.012″ to 0.016″), the pressure exerted is sufficient to pass various pin retention tests. Other embodiments may be able to use a thinner material and/or a different metal formulation.

The use of the U-shaped channel configuration of the interior portion of the connecting lead results in the impedance matching up with the desired target impedance of 75 Ohms (nominal). Further, the use of the U-shaped channel configuration facilitates formation of the connecting lead, in that machinery and techniques for forming a 90° bend in sheet metal for forming connectors is well known. The front and back insulators can be injection molded from a plastic with the suitable dielectric constant.

Other prior art connectors rely on a tubular shaped connecting lead, into which the center conductor is inserted. However, the tubular shape is formed by rolling sheet metal, and the small diameter that must be formed to effectively contact the center conductor limits the maximum thickness of sheet metal that can be used. In such type of connectors, the metal thickness is typically approximately 0.010″. However, such tubular shapes do not always pass the above identified pin retention tests, because the relatively thinner sheet metal is not able to provide the necessary gripping force to provide the necessary retention force. Using a thicker sheet metal (0.014″) formed as described above allows forming a connecting lead that can pass the gripping tests and can be easily formed. Such a thicker sheet metal, however, cannot be easily formed into a small enough tubular shape because the metal is thicker than can conventionally be formed using existing machineries. Further, the particular shape (e.g., asymmetric nature) of the contact is not easily recognized as a shape that is compatible with a 75 ohm F-connector structure.

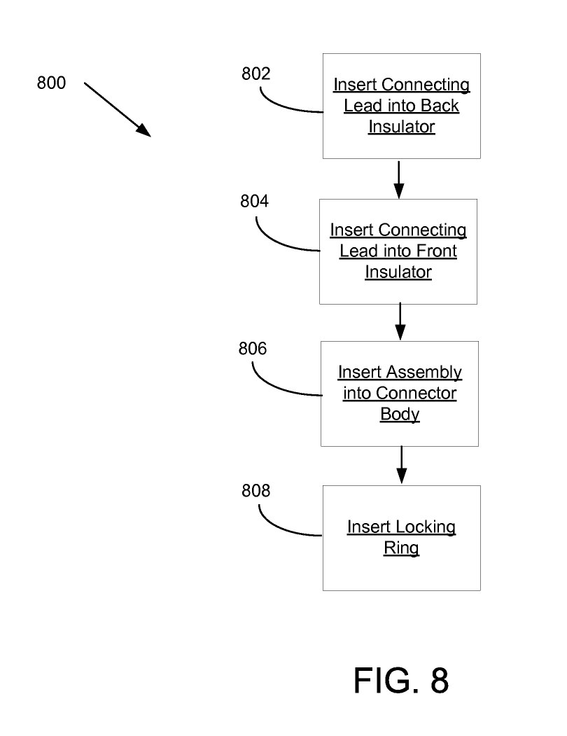

The process for assembling a connector is described in FIG. 8. The process 800 presumes that the connector leads, front and back insulators, locking ring, and connector body are already formed. The first step 802 involves inserting the connecting lead 250 into the back insulator 230 and positioning it so that the locking tabs 328 engage the key by snapping in place. In step 804, the front insulator is attached by engaging the receptacle 333 with the nose piece 610. Then, in step 806, the assembly is inserted into the connector body 220 from the back until the front insulator mates with the opening of the connector body 220. In step 808, the locking ring is pressed into place to hold the assembly together. In other embodiments, the locking ring is not required and the collar 355 of the back insulator is pressure fitted into the connector body 220 and held in place by friction.

In other embodiments, the components may be fitted into each other in different ways or in a different order. In lieu of locking tabs 328, other friction, adhesive, or attaching means known to those skilled in the may be used to affix the connecting lead with the back/front insulators. For example, the connecting lead 250 could be heated to weld the insulators to the connecting lead, or the insulators could be injection molded around the connecting lead. Those skilled in art may develop other variations for assembling or forming the components, such as forming a one-piece combination front and back insulator, into which the connecting lead may be inserted or positioned. Other variations of the configurations disclosure herein may be employed while maintaining a channel-like structure of the interior portion of the connecting lead to achieve the desired impedance and providing sufficient gripping force to pass the gripping tests. The principles of the present disclosure can be adapted for other impedances and other coaxial cables, and for other applications.

Based on the foregoing, it should be appreciated that an F-connector is disclosed for coaxial cable that provides a desired impedance value, as well as provides a strong retention force on the center conductor of the coaxial cable. It should also be appreciated that the subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A coaxial connector comprising:
a front insulator having a front side and a back side, comprising a hole configured to receive a center conductor of a coaxial cable;
a connecting lead comprising an external portion and an internal portion,
wherein the internal portion has three sides forming a U-shaped channel formed by a first side wall portion, a second side wall portion, and a bottom portion, wherein the first side wall portion is substantially parallel to the second side wall portion, and the first side wall portion and the second side wall portion are substantially the same length as the bottom portion, and
a back insulator, spaced apart from the front insulator, having an opening configured to receive said connecting lead, said back insulator affixed to the connecting lead by engaging with the first side wall portion and the second side wall portion.

2. The coaxial connector of claim 1 wherein the first side wall portion and the second side wall portion each have a curved part configured to contact the center conductor of a coaxial cable.

3. The coaxial connector of claim 1 wherein the metal is sheet metal having a thickness of at least 0.012″.

4. The coaxial connector of claim 2 wherein the connecting lead is configured to grip the center conductor part with sufficient force to prevent withdrawal of the center conductor by a force in the range of approximately 25 grams to approximately 200 grams.

5. The coaxial connector of claim 1 wherein the back insulator has a key engaging a first locking tab on the first side wall portion and a second locking tab on the second side wall portion.

6. The coaxial connector of claim 1 further comprising:
a connector body into which the front insulator, the back insulator, and the interior portion of the connecting lead are inserted into, wherein the bottom portion is supported at a first end by the front insulator and at a second location by the back insulator.

7. The coaxial connector of claim 6 wherein an airspace exists between each side wall portion and the connector body, and wherein the airspace and internal portion are configured such that the connector has a nominal impedance of at least 75 Ohms.

8. (canceled)

9. An apparatus, comprising:
a connecting lead having an interior portion configured to be within a coaxial connector body, and an exterior portion configured to be outside the connector body,
wherein the interior portion of the connecting lead comprises a U-shaped channel shaped by a first side wall, a second side wall substantially parallel to the first side wall, and a bottom portion, wherein the first side wall, second side wall and the bottom portion are substantially the same length,
wherein the first side wall and the second side wall are substantially adjacent and perpendicular to the bottom portion along their respective lengths, and
wherein the first side wall and second side wall are configured to grip a center conductor of a coaxial cable.

10. The apparatus of claim 9 wherein the first side wall and the second side wall are configured to grip the center conductor of the coaxial connector so as to prevent withdrawal of the center conductor by a force in the range of approximately 25 grams to approximately 200 grams.

11. The apparatus of claim 10 further comprising:
a front insulator affixed to the connecting lead;
a back insulator, spaced apart from the front insulator, affixed to the connecting lead; and
a connector body, into which the front insulator, back insulator, and the interior portion of the connecting lead are positioned,
wherein the apparatus has a nominal impedance of at least 75 Ohms.

12. The apparatus of claim 11,
wherein the first and second side wall each comprises a curved portion, wherein each respective curved portion is configured to grip the center conductor of the coaxial connector.

13. The apparatus of claim bottom portion is supported at a first end by the front insulator and at a second location by the back insulator.

14. The apparatus of claim 11 further comprising:
a locking ring positioned against the back insulator inside the connector body.

15. The apparatus of claim 11 wherein a locking tab protrudes from each side wall and grips a key of the back insulator.

16. The apparatus of claim 11 wherein the front insulator comprises a hole to receive a center conductor comprising 18 AWG wire.

17. The apparatus of claim 16 wherein the connector body comprises 3/8-32 UNEF threads.

18. A method of assembling an F-connector comprising:
affixing a back insulator to a connector lead;
affixing a front insulator, spaced apart from the back insulator, to the connector lead;
inserting the front insulator, back insulator, and a portion of the connector lead inside a connector body,
wherein the connector lead comprises a U-shaped channel comprising a first side wall portion and a second side wall portion, wherein the first side wall portion is substantially parallel to the second side wall portion, and each side wall portion is substantially adjacent and perpendicular to a bottom portion along their respective lengths,
wherein the first side wall portion and the second side wall portion are configured to grip the center conductor of a coaxial cable.

19. The method of claim 17 wherein the connector has a nominal impedance of at least 75 Ohms and is configured to prevent withdrawal of the center conductor by a force in the range of approximately 25 grams to approximately 200 grams.

20. The method of claim 18 further comprising:
inserting a locking ring in the connector body.
